(19) United States
(12) Patent Application Publication
(10) Pub. No.: US 2006/0053959 A1
(43) Pub. Date: Mar. 16, 2006

(54) Energy storage flywheel

(76) Inventors: Sun Soon Park, Hwaseong-city (KR); Sung Kyu Ha, Ansan-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/024,867

(22) Filed: Dec. 28, 2004

(30) Foreign Application Priority Data
Jul. 16, 2004 (KR) 10-2004-0055540

(51) Int. Cl. F16C 15/00

(52) U.S. Cl. 74/572.2

(57) ABSTRACT

An energy storage flywheel includes a rotating shaft, a hollow type hub coupled to the rotating shaft and concentrically arranged about the rotating shaft, and an annular rotor disposed on an outer surface of the hollow type hub and concentrically arranged about the rotating shaft. The hollow type hub comprises a cylindrical contacting portion contacting the rotor, and at least two dome type fixing portions respectively extending in a dome shape from the contacting portion and respectively being coupled to the rotating shaft.

### CROSS REFERENCE TO RELATED APPLICATION

This application claims priority to Korean Application No. 10-2004-0055540, filed on Jul. 16, 2004, the disclosure of which is incorporated herein by reference.

### FIELD OF THE INVENTION

Generally, the present invention relates to an energy storage device. More particularly, the present invention relates to an energy storage flywheel.

### BACKGROUND OF THE INVENTION

Energy storage systems using a flywheel, as is well known in the art, operates a motor using a redundant electric power and store inertia energy of a rotating member that rotates together with the motor. Such an energy storage system has an advantage of having greater energy storage efficiency than a conventional mechanical energy storage device or a chemical energy storage device.

Due to this advantage, the energy storage system using the flywheel is adapted in various devices such as an auxiliary power source of an electric vehicle, an uninterruptible power supply, a pulse power generator, and a satellite.

The energy storage system using a flywheel includes a flywheel storing inertia energy, and a motor for operating the flywheel.

The flywheel is generally composed of a rotor, a rotating shaft, and a hub for fixing the rotor and the rotating shaft together.

Rotating kinetic energy that is stored in the flywheel can be determined as a value according to the following equation.

$$E = \frac{1}{2} I {ω}^{2}$$

where I is a moment of inertia and ω is a rotation speed.

As is known from this equation, the energy is linearly proportional to the moment of inertia, and to increase the rotation speed is very effective for increasing the energy, rather than increasing a size of the flywheel.

However, because a conventional flywheel is made of metal having low tensile strength, it is impossible for the flywheel to rotate at high speed.

Due to development of a new high strength composite material, the flywheel can rotate at very high speed, e.g., at a speed of about 100,000 rpm.

That is, an energy density per unit mass and unit volume of the flywheel is substantially increased, so it becomes possible to develop an energy storage system having a high efficiency.

Because the flywheel has relatively small strength in a radial direction thereof, a tensile stress in a radial direction of the flywheel may cause serious damages on the flywheel. In order to prevent such damages due to tensile stress in a radial direction, the rotor is composed of a plurality of composite rings, so that an inner composite ring can be expanded in a radial direction while rotating at high speed, thereby decreasing a tensile stress.

In order to couple the rotor having multiple rings to the rotating shaft, a hub that is easily expandable in a radial direction must be provided. That is, because the rotor may be apt to be separated from the hub, a coupling between the hub and the rotor must be considered.

The flywheel must be designed to satisfy the following characteristics. At first, the flywheel must be designed to decrease internal stress that is generated by a rotation at high speed. Furthermore, the flywheel must be designed to have a resonant frequency (rpm) different from an operating speed.

To satisfy the above-stated characteristics, various new designs of the hub have been introduced. However, these designs are not without drawbacks. For example, in one design with a solid hub, referring to FIG. 3, a problem that tensile stress, i.e., strength ratio, becomes very high at high speed. Also it can be difficult to couple and separate such a hub from the rotor. In another design, with a hollow hub, although tensile stress near a contacting portion of the hub and rotor can be decreased, resonant frequency becomes low, referring to FIG. 7.

The information disclosed in this Background of the Invention section is only for enhancement of understanding of the background of the invention and should not be taken as an acknowledgement or any form of suggestion that this information forms the prior art that is already known in this country to a person of ordinary skill in the art.

### SUMMARY OF THE INVENTION

Embodiments of the present invention provide an energy storage flywheel in which a tensile stress can be decreased and a resonant frequency is relatively high.

An exemplary energy storage flywheel according to an embodiment of the present invention includes a rotating shaft, a hollow type hub coupled to the rotating shaft and concentrically arranged about the rotating shaft and an annular rotor disposed on an outer surface of the hollow type hub and concentrically arranged about the rotating shaft. The hollow type hub comprises a cylindrical contacting portion contacting the rotor, and at least two dome type fixing portions respectively extending in a dome shape from the contacting portion and respectively being coupled to the rotating shaft.

A plurality of slots may be formed in the hollow type hub along a longitudinal direction thereof.

The plurality of slots may be formed equidistantly along a circumferential direction of the hollow type hub.

Each slot may be formed to be longer than a length of the cylindrical contacting portion, and may be formed toward a center of the rotating shaft.

A number of the plurality of slots may be determined depending on a structural strength and a resonant frequency of the rotor.

The at least two dome type fixing portions may include two opposed dome type fixing portions that are respectively disposed at each end of the cylindrical contacting portion.

The two opposed dome type fixing portions may be respectively formed to be outwardly convex.

The at least two dome type fixing portions may further comprise an intermediate dome type fixing portion that is disposed between the two opposed dome type fixing portions.

The two opposed dome type fixing portions may be respectively formed to be inwardly convex.

One of the two opposed dome type fixing portions may be formed to be inwardly convex, and the other of the two opposed dome type fixing portions is formed to be outwardly convex.

The at least two dome type fixing portions may include two opposed dome type fixing portions, and wherein one of the two opposed dome type fixing portions is disposed at one end of the cylindrical contacting portion, and the other of the two opposed dome type fixing portions is disposed between both ends of the cylindrical contacting portion.

A number of the at least two dome type fixing portions may be determined depending on a structural strength and a resonant frequency of the rotor.

In another embodiment of the present invention, an energy storage flywheel includes: a rotating shaft; a hollow type hub coupled to the rotating shaft, wherein the hollow type hub is concentrically arranged about the rotating shaft; and an annular rotor disposed on an outer surface of the hollow type hub and concentrically arranged about the rotating shaft. The hollow type hub includes a cylindrical contacting portion contacting the rotor, and a dome type fixing portion extending from the contacting portion and coupled to the rotating shaft. A plurality of slots are formed in the hollow type hub along a longitudinal direction thereof.

### BRIEF DESCRIPTION OF THE DRAWINGS

The accompanying drawings illustrate exemplary embodiments of the present invention, and, together with the description, serve to explain the principles of the present invention, wherein:

FIG. 1 is a perspective view, partly cut away, of an energy storage flywheel according to an embodiment of the present invention;

FIG. 2 is a perspective view, partly cut away, of a hub of the energy storage flywheel of FIG. 1;

FIG. 3 is a diagram illustrating radial strength ratios at the speed of 30,000 rpm of energy storage flywheels according to an embodiment of the present invention, the first prior art, and the second prior art;

FIG. 4 is a diagram illustrating maximum strength ratios of energy storage flywheels according to an embodiment of the present invention, the first prior art, and the second prior art;

FIG. 5 is a diagram illustrating resonant frequencies of energy storage flywheels according to an embodiment of the present invention, the first prior art, and the second prior art;

FIG. 6 is a diagram illustrating maximum rotation speeds, in consideration of the radial strength ratio and the resonant frequency, of energy storage flywheels according to an embodiment of the present invention, the first prior art, and the second prior art;

FIG. 7 is a diagram illustrating maximum energies of energy storage flywheels according to an embodiment of the present invention, the first prior art, and the second prior art;

FIGS. 8-11 are perspective views, partly cut away, of hubs of energy storage flywheels according to alternate embodiments of the present invention.

### DETAILED DESCRIPTION OF THE EMBODIMENTS

An embodiment of the present invention will hereinafter be described in detail with reference to the accompanying drawings.

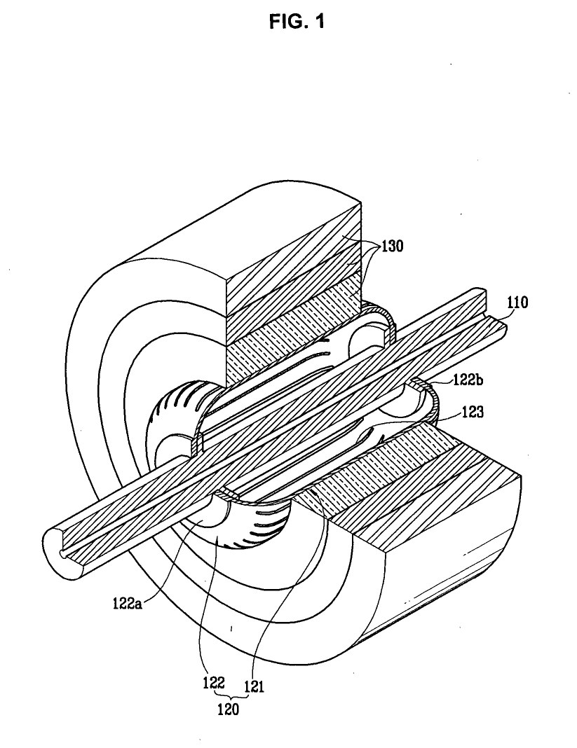

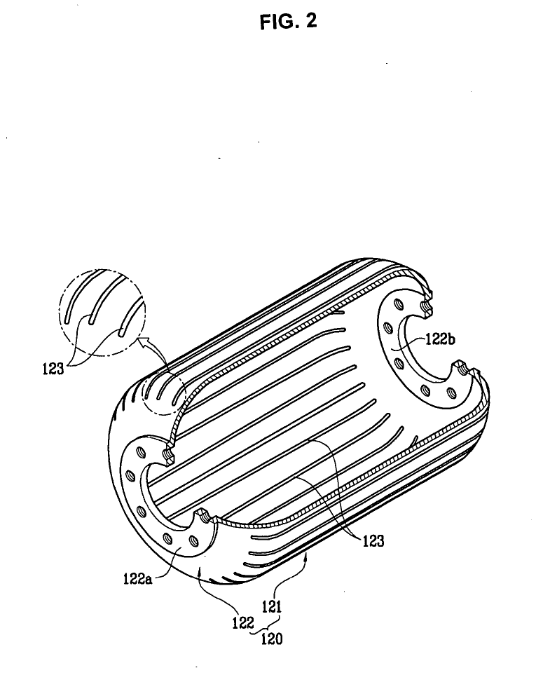

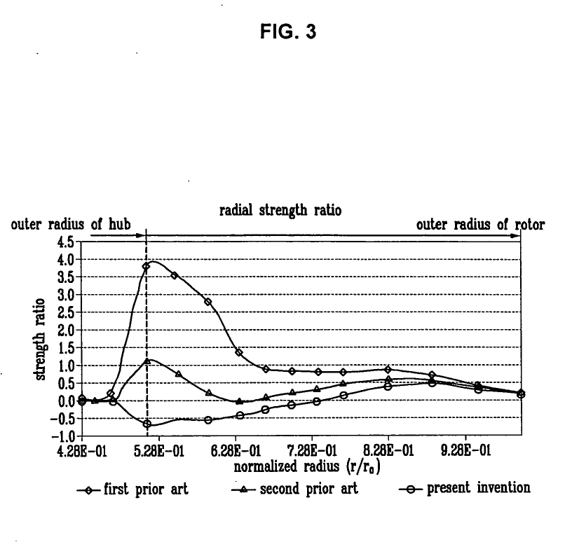

An energy storage flywheel according to an embodiment of the present invention, as shown in FIGS. 1 and 2, includes a rotating shaft 110, a hollow type hub 120, and an annular rotor 130. The hollow type hub 120 is coupled to the rotating shaft 110 and is concentrically arranged about the rotating shaft 110. The annular rotor 130 is disposed on an outer surface of the hollow type hub 120 and is concentrically arranged about the rotating shaft 110. For example, as shown in FIG. 3, the annular rotor 130 may be a multi-layer type rotor having a plurality of annular layers, and it may be made of a composite material.

The hollow type hub 120 includes a cylindrical contacting portion 121 contacting the annular rotor 130, and at least two dome type fixing portions 122. Each of the dome type fixing portions 122 extends in a dome shape from the contacting portion 121 and is coupled to the rotating shaft 110.

A plurality of slots 123 are formed in the hollow type hub 120 along a longitudinal direction thereof.

The plurality of slots 123 may be formed equidistantly along a circumferential direction of the hollow type hub 120. Therefore, while the flywheel rotates at a high speed, the contacting portion 121 can be outwardly equally expanded.

In addition, each of the plurality of slots 123 may be formed to be longer than a length of the contacting portion 121. That is, as shown in FIGS. 1 and 2, the slots 123 are extended to a portion of the dome type fixing portions 122. Therefore, while the flywheel rotates at a high speed, the contacting portion 121 can be outwardly easily expanded.

Each of the plurality of slots 123 is formed toward a center of the rotating shaft 110. Therefore, the contacting portion 121 can be precisely outwardly expanded in a radial direction while the flywheel rotates at a high speed, and furthermore, a compression force caused by an expansion can be equally distributed on an inner surface of the rotor 130.

Furthermore, if a compression force is applied on the inner surface of the annular rotor 130, a stress in a radial direction of the rotor 130 can be lowered. Detailed explanations for this will be made below.

A number of the plurality of slots 123 may be determined depending on a structural strength and a resonant frequency of the annular rotor 130.

The at least two dome type fixing portions 122 include two opposed dome type fixing portions, i.e., a first dome type fixing portion 122a and a second dome type fixing portion 122b, that are respectively disposed at each end of the cylindrical contacting portion 121. The first and second dome type fixing portions 122a and 122b are respectively formed to be outwardly convex.

Hereinafter, referring to FIGS. 3-7, an energy storage flywheel according to an embodiment of the present invention is compared to energy storage flywheels according to the first and second prior arts.

FIG. 3 is a diagram illustrating radial strength ratios at the speed of 30,000 rpm of energy storage flywheels according to an embodiment of the present invention, the first prior art, and the second prior art.

Here, a strength ratio is a dimensionless value that is obtained by dividing a stress by a strength of material of the flywheel. If the strength ratio is less than 1, it is supposed that the flywheel can safely operate. If the strength ratio is greater than 1, it is supposed that the flywheel cannot safely operate.

The solid hub type flywheel (first prior art) and the hollow hub flywheel (second prior art) have relatively great radial strength ratios, when compared to the flywheel according to an embodiment of the present invention. For example, referring to FIG. 3, the strength ratio of the flywheel according to the first prior art is very high at a radial position where an outer surface of the hub contacts an inner surface of the rotor, i.e., at a position corresponding to an outer radius of the hub where the normalized radius r/r₀ is about 0.528. Because a radial displacement of the hub is less than that of the rotor, a great tensile stress is generated. This causes a relatively great strength ratio in the flywheel according to the first prior art. In FIG. 3, “r” is a variable indicating a radius of a specific radial point, and “r₀” is a constant indicating an outer radius of the rotor. Similarly, the strength ratio of the flywheel according to the second prior art is also high at a radial position where an outer surface of the hub contacts an inner surface of the rotor.

On the other hand, in the flywheel according to an embodiment of the present invention, a compression force is generated near the radial position where an outer surface of the hub contacts an inner surface of the rotor. Because a radial displacement of the hollow type hub 120 is greater than that of the rotor 130, a compression force is applied to the rotor 130.

In the flywheel according to an embodiment of the present invention, because the stress of the rotor 130 is decreased by the compression force, the strength ratios of the flywheel according to an embodiment of the present invention are generally lower than those of the flywheels according to the first and second prior arts.

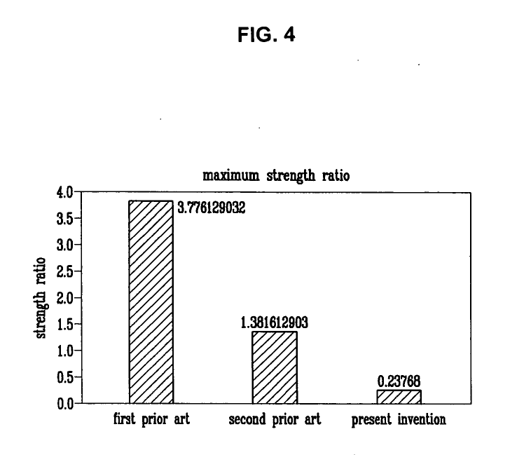

FIG. 4 is a diagram illustrating maximum strength ratios of energy storage flywheels according to an embodiment of the present invention, the first prior art, and the second prior art. In particular, maximum strength ratios of the flywheels are shown in FIG. 4 when the flywheels rotate at the speed of 30,000 rpm.

The maximum strength ratio of the flywheel according to the first prior art is about 3.77, and the maximum strength ratio of the flywheel according to the second prior art is about 1.38. Therefore, at the speed of 30,000 rpm, the flywheels according to the first and second prior arts cannot safely operate.

On the other hand, the maximum strength ratio of the flywheel according to an embodiment of the present invention is about 0.24. Therefore, at the speed of 30,000 rpm, the flywheel according to an embodiment of the present invention can safely operate.

Consequently, as is known in FIGS. 3 and 4, in terms of a radial displacement, the flywheel according to an embodiment of the present invention is stable, and the stress of the rotor can be substantially decreased.

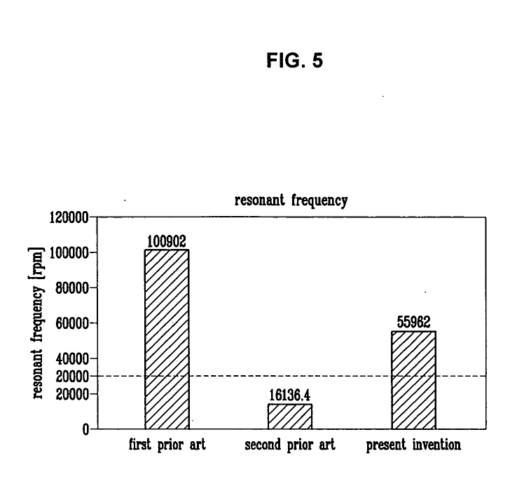

Referring to FIG. 5, the resonant frequency of the flywheel according to the first prior art is 100,902 rpm, which is greater than both of those of the flywheels according to an embodiment of the present invention and the second prior art, so the flywheel according to the first prior art is the most stable among the three flywheels. A resonant frequency of the flywheel according to the second prior art is 16,134.4 rpm, which is less than both of those of the flywheels according to an embodiment of the present invention and the first prior art, so the flywheel according to the second prior art is the most unstable among the three flywheels. This is caused by the fact that the hub is coupled to the rotating shaft through only one portion.

On the other hand, a resonant frequency of the flywheel according to an embodiment of the present invention is 55,962 rpm, which is greater than that of the flywheel according to the second prior art, because the hollow hub 120 is coupled to the rotating shaft 110 through two fixing portions, i.e., the first fixing portion 122a and the second fixing portion 122b.

In addition, as is known from the FIGS. 4 and 5, when the flywheel rotates at the speed of 30,000 rpm, the strength ratio of the flywheel according to an embodiment of the present invention is less than 1, and the resonant frequency of the flywheel according to an embodiment of the present invention is greater than the operating speed 30,000 rpm. Therefore, the flywheel according to an embodiment of the present invention can safely operate at the speed of 30,000 rpm.

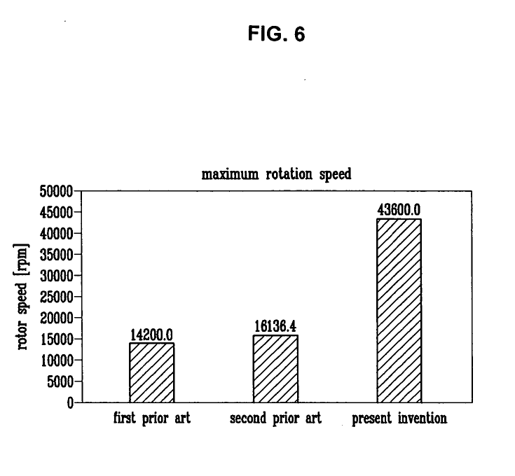

FIG. 6 is a diagram illustrating maximum rotation speeds at which the flywheel can normally operate, in consideration of the radial strength ratio and the resonant frequency, of energy storage flywheels according to an embodiment of the present invention, the first prior art, and the second prior art. The maximum rotation speed indicates a maximum rotation speed of the flywheel simultaneously satisfying the strength ratio and the resonant frequency of the flywheel.

The maximum rotation speed of the flywheel according to an embodiment of the present invention is 43,600 rpm, which is greater than those of the flywheels according to the first and second prior arts. Therefore, the flywheel according to an embodiment of the present invention can rotate faster than flywheels according to the first and second prior arts, while guaranteeing safe operation.

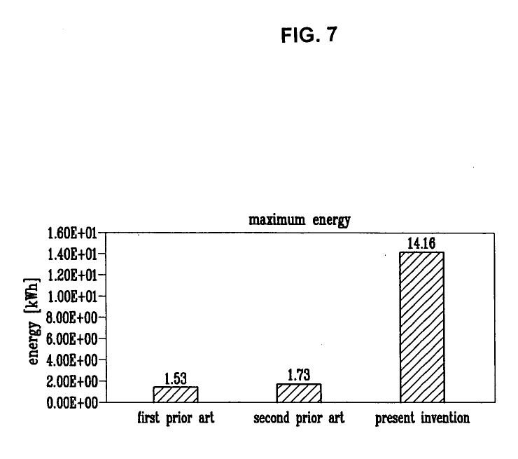

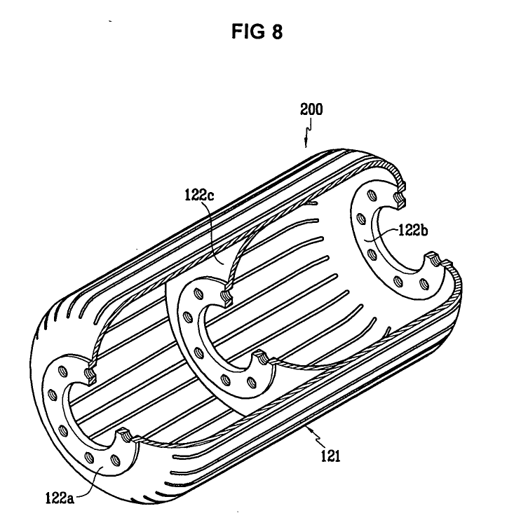

Referring to FIG. 7, the maximum storage energy of the flywheel according to an embodiment of the present invention is 14.16 KWh, which is much greater than those of the flywheels according to the first and second prior arts. An amount of energy stored in the flywheel is proportional to the square of the rotation speed, as above-stated. Because the maximum rotation speed of the flywheel according to an embodiment of the present invention is, as shown in FIG. 8, greater than those of the flywheels according to the first and second prior arts, the maximum storage energy of the flywheel according to an embodiment of the present invention is also greater than those of the flywheels according to the first and second prior arts.

Hereinafter, referring to FIGS. 8-11, hubs of energy storage flywheels according to alternate embodiments of the present invention will be explained.

Same reference numerals will be used for components of the flywheel of FIGS. 1 and 2 that are not changed.

In an alternate embodiment, a hub 200 includes, as shown in FIG. 8, two dome type fixing portions 122a and 122b that are respectively disposed at each end of the cylindrical contacting portion 121, and an intermediate dome type fixing portion 122c that is coupled to an inner surface of the contacting portion 121. That is, the intermediate dome type fixing portion 122c is disposed between the two opposed dome type fixing portions 122a and 122b.

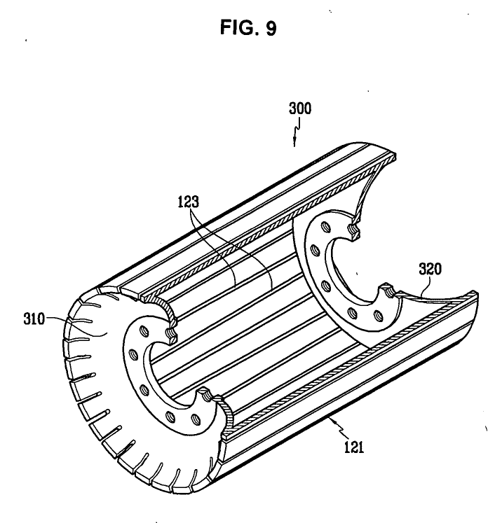

In another alternate embodiment, a hub 300 includes, as shown in FIG. 9, two opposed dome type fixing portions 310 and 320 that are respectively disposed at each end of the cylindrical contacting portion 121 and are respectively formed to be inwardly convex.

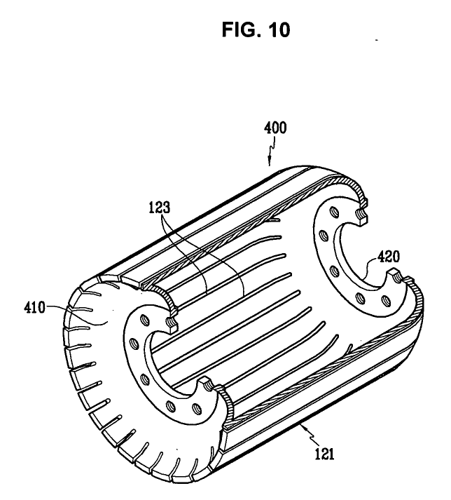

In yet another alternate embodiment, a hub 400 includes, as shown in FIG. 10, two opposed dome type fixing portions 410 and 420 that are respectively disposed at each end of the cylindrical contacting portion 121. The dome type fixing portion 410 is formed to be inwardly convex, and the dome type fixing portion 420 is formed to be outwardly convex.

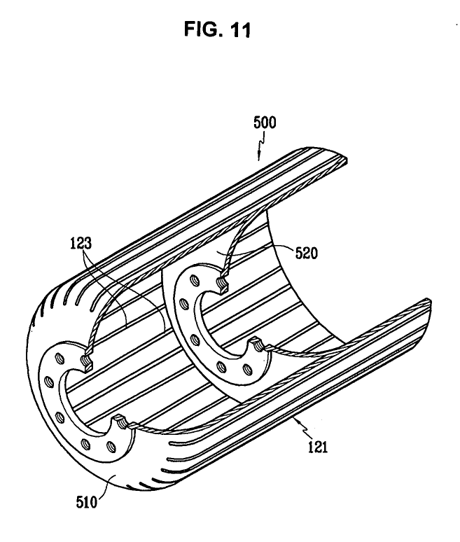

In still another alternate embodiment, a hub 500 includes, as shown in FIG. 11, two opposed dome type fixing portions 510 and 520. The dome type fixing portion 510 is disposed at one end of the cylindrical contacting portion 121, and the dome type fixing portion 520 is coupled to an inner surface of the contacting portion 121. That is, the dome type fixing portion 520 is disposed between both ends of the cylindrical contacting portion 121.

A number of the dome type fixing portions may be determined depending on a structural strength and a resonant frequency of the rotor 130.

While this invention has been described in connection with what is presently considered to be the most practical exemplary embodiments, it is to be understood that the invention is not limited to the disclosed embodiments, but, on the contrary, is intended to cover various modifications and equivalent arrangements included within the spirit and scope of the appended claims.

According to an embodiment of the present invention, because the hub is provided with at least two dome type fixing portions, a resonant frequency of the flywheel becomes relatively high, when compared to the conventional flywheel having a hollow hub.

In addition, because slots are formed in the hollow hub, a compression force is applied to an inner surface of the rotor, so that a tensile strength of the rotor can be lowered.

What is claimed is:

1. An energy storage flywheel, comprising:
a rotating shaft;
a hollow type hub coupled to the rotating shaft and concentrically arranged about the rotating shaft; and
an annular rotor disposed on an outer surface of the hollow type hub and concentrically arranged about the rotating shaft, wherein the hollow type hub comprises
a cylindrical contacting portion contacting the rotor, and
at least two dome type fixing portions respectively extending in a dome shape from the contacting portion and respectively being coupled to the rotating shaft.

2. The energy storage flywheel of claim 1, wherein a plurality of slots are formed in the hollow type hub along a longitudinal direction thereof.

3. The energy storage flywheel of claim 2, wherein the plurality of slots are formed equidistantly along a circumferential direction of the hollow type hub.

4. The energy storage flywheel of claim 2, wherein each slot is formed to be longer than a length of the cylindrical contacting portion.

5. The energy storage flywheel of claim 2, wherein each slot is formed toward a center of the rotating shaft.

6. The energy storage flywheel of claim 5, wherein a number of the plurality of slots is determined depending on a structural strength and a resonant frequency of the rotor.

7. The energy storage flywheel of claim 1, wherein the at least two dome type fixing portions comprise two opposed dome type fixing portions that are respectively disposed at each end of the cylindrical contacting portion.

8. The energy storage flywheel of claim 7, wherein the two opposed dome type fixing portions are respectively formed to be outwardly convex.

9. The energy storage flywheel of claim 7, wherein the at least two dome type fixing portions further comprise an intermediate dome type fixing portion that is disposed between the two opposed dome type fixing portions.

10. The energy storage flywheel of claim 7, wherein the two opposed dome type fixing portions are respectively formed to be inwardly convex.

11. The energy storage flywheel of claim 7, wherein one of the two opposed dome type fixing portions is formed to be inwardly convex, and the other of the two opposed dome type fixing portions is formed to be outwardly convex.

12. The energy storage flywheel of claim 1, wherein the at least two dome type fixing portions comprise two opposed dome type fixing portions, and wherein one of the two opposed dome type fixing portions is disposed at one end of the cylindrical contacting portion, and the other of the two opposed dome type fixing portions is disposed between both ends of the cylindrical contacting portion.

13. The energy storage flywheel of claim 1, wherein a number of the at least two dome type fixing portions is determined depending on a structural strength and a resonant frequency of the rotor.

14. An energy storage flywheel, comprising:
a rotating shaft;
a hollow type hub coupled to the rotating shaft, wherein the hollow type hub is concentrically arranged about the rotating shaft; and
an annular rotor disposed on an outer surface of the hollow type hub and concentrically arranged about the rotating shaft,
wherein the hollow type hub comprises a cylindrical contacting portion contacting the rotor, and a dome type fixing portion extending from the contacting portion and coupled to the rotating shaft, and wherein a plurality of slots are formed in the hollow type hub along a longitudinal direction thereof.
